(19) United States
(12) Patent Application Publication
(10) Pub. No.: US 2014/0248524 A1
(43) Pub. Date: Sep. 4, 2014

(54) BATTERIES AND METHODS OF MANUFACTURING BATTERIES

(71) Applicant: Honeywell International Inc., Morristown, NJ (US)

(72) Inventors: Wei Jung Wang, Shanghai (CN); Yanming Shen, Shanghai (CN); Hanjin Huang, Shanghai (CN)

(21) Appl. No.: 14/188,988

(22) Filed: Feb. 25, 2014

Related U.S. Application Data
(60) Provisional application No. 61/771,207, filed on Mar. 1, 2013.

(51) Int. Cl. H01M 2/08; H01M 2/02; H01M 6/22; H01M 6/40

(52) U.S. Cl. CPC H01M 2/08; H01M 6/40; H01M 2/0287; H01M 2/0292; H01M 2/0267; H01M 6/22
USPC 429/124; 156/182

(57) ABSTRACT

Disclosed is a paper battery that includes a cellulosic substrate having absorbed thereon an electrolyte material and first and second barrier substrates disposed on opposite sides of the cellulosic substrate. Each of the first and second barrier substrates have an electrode printed thereon. At least one of the first and second barrier substrates includes first and second polymer layers. Further disclosed is a method of manufacturing a paper battery that includes the steps of absorbing an electrolyte material onto a cellulosic substrate and disposing on opposite sides of the cellulosic substrate first and second barrier substrates. Each of the first and second barrier substrates have an electrode printed thereon. At least one of the first and second barrier substrates includes first and second polymer layers.

### CROSS-REFERENCE TO RELATED APPLICATION

This application claims the benefit of priority to U.S. provisional application Ser. No.: 61/771,207, filed on Mar. 1, 2013, the contents of which are herein incorporated by reference in their entirety.

### FIELD OF THE DISCLOSURE

The present disclosure generally relates to batteries and methods of manufacturing batteries.

### BACKGROUND

A “paper battery” is known in the art as a thin electric battery that employs a substrate that is formed largely of cellulose. Paper batteries are thin, flexible, and environment-friendly, which allows for their integration into a wide range of products. Paper batteries function in a manner that is analogous to conventional chemical batteries, but with the difference that paper batteries are non-corrosive and do not require a bulky housing. Exemplary uses for paper batteries include radio frequency identification (RFID) devices, medical diagnostic equipment, and drug delivery transdermal patches.

Paper batteries are manufactured by absorbing an electrolyte onto a cellulose substrate. The electrolyte is moisture absorbing, especially when the paper battery is used in a high temperature and/or high humidity application. Any water ingress into the cellulose substrate causes a marked decrease in battery performance. To help protect the battery against moisture intrusion, and to maintain the flexibility of the battery, thin plastic films such as polyethylene terephthalate (PET) with an aluminum coating are adhered to the battery as an exterior packaging layer and as a “barrier” layer against moisture. The PET/aluminum films are also used as a substrate to “print” the battery electrodes thereon using a conductive ink.

Paper batteries currently known in the art suffer from several drawbacks. The aluminum coated PET film barrier layer, which is often deposited via physical vapor deposition (PVD), does not provide a sufficient moisture barrier due in part to “pin holes” and scratch defects, which allow moisture to pass therethrough. Further, the aluminum coating has an electromagnetic shield effect, which is not favorable in many applications, such as RFID devices, where electromagnetic transmission is desirable.

As such, it would be desirable to provide improved paper batteries and methods for manufacturing paper batteries that have increased moisture resistance and that are not electromagnetically shielded. Further, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

In one exemplary embodiment, disclosed is a paper battery that includes a cellulosic substrate having absorbed thereon an electrolyte material and first and second barrier substrates disposed on opposite sides of the cellulosic substrate. Each of the first and second barrier substrates have an electrode printed thereon. At least one of the first and second barrier substrates includes first and second polymer layers.

In another exemplary embodiment, disclosed is a method of manufacturing a paper battery that includes the steps of absorbing an electrolyte material onto a cellulosic substrate and disposing on opposite sides of the cellulosic substrate first and second barrier substrates. Each of the first and second barrier substrates have an electrode printed thereon. At least one of the first and second barrier substrates includes first and second polymer layers.

In yet another exemplary embodiment, disclosed is a paper battery that includes a cellulosic substrate having absorbed thereon an electrolyte material that includes zinc chloride and first and second barrier substrates disposed on opposite sides of the cellulosic substrate. Each of the first and second barrier substrates have an electrode printed thereon. The electrode of the first barrier substrate includes zinc and the electrode of the second barrier substrate includes manganese dioxide. At least one of the first and second barrier substrates includes first and second polymer layers. The first polymer layer includes poly-cholortrifluoroethylene and the second polymer layer includes polyethylene terephthalate. Further, the first and second polymer layers are laminated or co-extruded together.

This brief summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE FIGURES

The present disclosure will hereinafter be described in conjunction with the following drawing figures, wherein like numerals denote like elements, and wherein:

FIG. 1 illustrates the structure of a paper battery, in cross-section, as is currently known in the art.

FIG. 2 illustrates the structure of a paper battery, in cross-section, in accordance with an exemplary embodiment of the present disclosure.

### DETAILED DESCRIPTION

The following Detailed Description is merely exemplary in nature and is not intended to limit the invention or the application and uses of the invention. Furthermore, there is no intention to be bound by any expressed or implied theory presented in the preceding Technical Field, Background, Brief Summary, or the following Detailed Description.

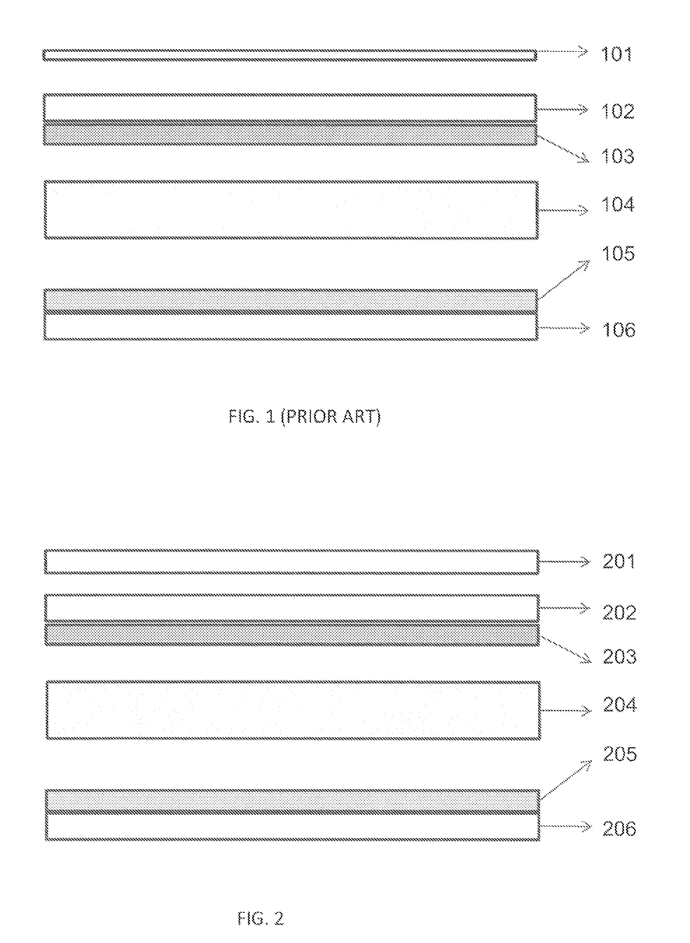

Embodiments of the present disclosure are broadly directed to paper batteries and methods of manufacturing paper batteries. FIG. 1 illustrates the structure of a paper battery, in cross-section, as is currently known in the art. Certain of the layers 101-106 depicted therein are shown separated from (non-adjacent to) one another for ease of illustration; however, it will be appreciated that in practice the layers 101-106 are adhered to one another to form an integrated and functioning battery.

The paper battery depicted in FIG. 1 generally includes at least a first electrode 103 including a first electrochemical layer (e.g., a cathode), a second electrode 105 including a second electrochemical layer (e.g., an anode), and an electrolyte disposed on a cellulosic substrate 104 that interacts with the electrodes to create an electrical current. All of the first and second electrodes (103, 105) and the electrolyte on the substrate 104 are typically contained between two or more barrier substrates 102, 106, which provide a substrate on which to “print” the electrodes 103, 105, as well as provide electrical isolation from the electrode and a moisture barrier to prevent moisture intrusion upon the electrolyte.

Regarding the first and second electrodes 103, 105, the deposition of the electrodes on respective barrier substrates 102, 106 can be accomplished by, for example, printing conductive and/or electrochemical inks and/or laminating a metallic foil, such as a zinc foil, for example, on one or more high-speed web printing presses with rotary screen and/or flexographic printing stations. Other suitable methods include web printing with flat-bed screens or a sheet-fed flat-bed printing press. A suitable material for use as the cathode 103 includes manganese dioxide (MnO₂). A suitable material for use as the anode 105 includes zinc. Other formulations of the cathode or anode may be used as are known in the art.

The cellulosic substrate 104 may be prepared from cellulosic fibers derived from wood pulp. Exemplary cellulosic fibers include, but are not limited to, those derived from wood, such as wood pulp, as well as non-woody fibers from cotton, from straws and grasses, such as rice and esparto, from canes and reeds, such as bagasse, from bamboos, from stalks with bast fibers, such as jute, flax, kenaf, cannabis, linen and ramie, and from leaf fibers, such as abaca and sisal. It is also possible to use mixtures of one or more cellulosic fibers. The cellulosic substrate 104 is immersed in an electrolyte solution to absorb the electrolyte solution on to the cellulosic substrate 104. Zinc chloride (ZnCl₂) in solution is an exemplary electrolyte, and can be used in the concentration range of about 18%-45% by weight, for example. Other suitable electrolyte formulations, such as ammonium chloride (NH₄Cl), mixtures of zinc chloride (ZnCl₂) and ammonium chloride (NH₄Cl), zinc acetate (Zn(C₂H₂O₂)), zinc bromide (ZnBr₂), zinc fluoride (ZnF₂), zinc tartrate (ZnC₄H₄O₆), zinc per-chlorate Zn(ClO4)₂), potassium hydroxide, sodium hydroxide, or organics, for example, could also be used.

The barrier substrates 102, 106 on which the electrodes 103, 105 are printed can be formed of a plastic film of, for example, a polypropylene or a polyethylene. In order to improve the moisture barrier properties of the barrier substrates 102, 106, one or more of the barrier substrates 102, 106 can be provided as a metallized film. The term metallized film refers to a polymer film layer with a metal layer coated thereon. As shown in FIG. 1, barrier substrate 102 includes a metal layer 101 disposed thereover. Examples of a suitable metallized film include metallized polyethylene teraphthalate (MPET) and metallized polypropylene (MPP). An exemplary metal for use as the metal coating layer 101 includes aluminum (Al).

As noted previously, when a metallized barrier substrate is employed, “pin hole” and scratch defects can occur in the metal coating, which allows moisture to pass therethrough. Further, the metal layer 101 has an electromagnetic shield effect, which is not favorable in applications where electromagnetic transmission is desirable. As such, embodiments of the present disclosure are directed to an improved paper battery structure that provides the increased moisture resistance of a metallized plastic/polymer film coating, but does not suffer the manufacturing and transmission shielding drawbacks that are commonly encountered in the paper batteries currently known in the art, as in FIG. 1.

Reference is now made to FIG. 2, which illustrates the structure of a paper battery, in cross-section, in accordance with an exemplary embodiment of the present disclosure. As with FIG. 1, certain of the layers 201-206 depicted therein are shown separated from (non-adjacent to) one another for ease of illustration; however, it will be appreciated that in practice the layers 201-206 are adhered to one another to form an integrated and functioning battery.

As shown in FIG. 2, layers 203-206 are substantially the same as layers 103-106, respectively, described above with regard to FIG. 1 (that is, layer 203 is a first electrode, e.g., a cathode, layer 204 is a cellulose substrate with an electrolyte absorbed thereon, layer 205 is a second electrode, e.g., an anode, and layer 206 is a polymeric barrier substrate). Rather than employing a metallized plastic/polymer layer (e.g., 101, 102 of FIG. 1) for protection against moisture intrusion and for a substrate on which to print the first electrode, embodiments of the present disclosure utilize first and second polymer layers 201, 202. In an exemplary embodiment, the second polymer layer 202 is formed of PET, which as noted above provides moisture barrier protection, and also serves as a substrate on which to print the electrode. The first polymer layer 201 is formed of poly-chlorotrifluoroethylene (poly-CTFE or PCTFE). In an alternative embodiment, the first polymer layer 201 is formed of poly-vinylidenechloride (poly-VDC or PVDC). In one embodiment, the first and second polymer layers 201, 202 may be formed together by lamination or co-extrusion. In another embodiment, layer 201 may be provided as a heat-sealable PCTFE barrier layer to adhere to layers 202 and/or 206. In yet another embodiment, the entire battery device may be encapsulated by a PCTFE encapsulant layer (not shown), thus layer 201 can be formed continuously around the entire device. In one embodiment, the thickness of the first and second polymer layers (laminated or co-extruded together) can range from about 25 microns to about 500 microns, for example from about 50 microns to about 300 microns.

### ILLUSTRATIVE EXAMPLE

The present disclosure is now illustrated by the following non-limiting example. It should be noted that various changes and modifications can be applied to the following example and processes without departing from the scope of this invention, which is defined in the appended claims. Therefore, it should be noted that the following example should be interpreted as illustrative only and not limiting in any sense.

A barrier substrate was prepared in accordance with FIG. 2, utilizing PCTFE as the first polymer layer and PET as the second polymer layer. The first and second polymer layers were laminated together. The combined thickness of the first and second polymers layers, after lamination, was about 280 microns.

A barrier substrate as is used on the SoftBattery® paper battery, which includes an aluminum coating PET substrate barrier layer as in the prior art example of FIG. 1, was commercially obtained from Enfucell Corporation of Vantaa, Finland for purposes of comparison. Measurements of this barrier substrate indicated that the aluminum coated PET substrate barrier layer was about 50 microns thick.

Both the prepared barrier substrate and the comparison barrier substrate were exposed to an atmosphere of 40° C. and 75% relative humidity. Moisture intrusion in the prepared barrier substrate was measured at 0.50 g/m²/day. Moisture intrusion in the commercially obtained comparison barrier substrate was measured at 5.50 g/m²/day.

As such, it has been surprisingly discovered by the inventors herein that a paper battery manufactured with first and second polymer layers as a barrier substrate (for example PCTFE and PET or PVDC and PET), in place of a metallized plastic film (for example Al coated PET), provides increased protection against moisture intrusion. Further, as the disclosed paper battery does not use a metal layer or a metal coating, blocking of electromagnetic transmissions is substantially avoided. The first and second polymer layers can be easily co-extruded with one another or laminated to one another, thereby providing a simple and cost-effective manufacturing process.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

1. A paper battery comprising:
a cellulosic substrate having absorbed thereon an electrolyte material; and
first and second barrier substrates disposed on opposite sides of the cellulosic substrate, each of the first and second barrier substrates having an electrode printed thereon, wherein at least one of the first and second barrier substrates comprises first and second polymer layers.

2. The paper battery of claim 1, wherein the first polymer layer comprises poly-cholortrifluoroethylene (PCTFE).

3. The paper battery of claim 2, wherein the PCTFE comprises a heat-sealable PCTFE.

4. The paper battery of claim 1, wherein the first polymer layer comprises poly-vinylidenechloride.

5. The paper battery of claim 1, wherein the second polymer layer comprises polyethylene teraphthalate.

6. The paper battery of claim 1, wherein the electrolyte material comprises zinc chloride.

7. The paper battery of claim 1, wherein at least one of the printed electrodes comprises zinc.

8. The paper battery of claim 1, wherein at least one of the printed electrodes comprises manganese dioxide.

9. The paper battery of claim 1, wherein the first polymer layer encapsulates the paper battery.

10. A method of manufacturing a paper battery comprising the steps of:
absorbing an electrolyte material onto a cellulosic substrate; and
disposing on opposite sides of the cellulosic substrate first and second barrier substrates, each of the first and second barrier substrates having an electrode printed thereon, wherein at least one of the first and second barrier substrates comprises first and second polymer layers.

11. The method of claim 10, wherein the first polymer layer comprises poly-cholortrifluoroethylene (PCTFE).

12. The method of claim 11, wherein the PCTFE comprises a heat-sealable PCTFE.

13. The method of claim 10, wherein the first polymer layer comprises poly-vinylidenechloride.

14. The method of claim 10, wherein the second polymer layer comprises polyethylene teraphthalate.

15. The method of claim 10, wherein the electrolyte material comprises zinc chloride.

16. The method of claim 10, wherein at least one of the printed electrodes comprises zinc.

17. The method of claim 10, wherein at least one of the printed electrodes comprises manganese dioxide.

18. The method of claim 10, wherein the at least one of the first and second barrier substrates is formed by laminating or co-extruding the first and the second polymer layers together.

19. The method of claim 10, further comprising encapsulating the paper battery with the first polymer layer.

20. A paper battery comprising:
a cellulosic substrate having absorbed thereon an electrolyte material comprising zinc chloride; and
first and second barrier substrates disposed on opposite sides of the cellulosic substrate, each of the first and second barrier substrates having an electrode printed thereon, the electrode of the first barrier substrate comprising zinc and the electrode of the second barrier substrate comprising manganese dioxide, wherein at least one of the first and second barrier substrates comprises first and second polymer layers, the first polymer layer comprising poly-cholortrifluoroethylene and the second polymer layer comprising polyethylene terephthalate, the first and second polymer layers being laminated or co-extruded together.
